(19) United States
(12) Patent Application Publication
(10) Pub. No.: US 2004/0206302 A1
(43) Pub. Date: Oct. 21, 2004

(54) Glass frosting and container device

(76) Inventor: Alan D. Propp, Aurora, CO (US)

Correspondence Address: AKIN, GUMP, STRAUSS, HAUER & FELD, 1111 LOUISIANA STREET, 44TH FLOOR, HOUSTON, TX, 77002, US

(21) Appl. No.: 10/419,448

(22) Filed: Apr. 21, 2003

(51) Int. Cl. A23G 3/20; A21C 9/04

(52) U.S. Cl. 118/13; 215/394; 220/575

(57) ABSTRACT

A glass frosting and container device is provided for coating a rim of a glass with a frosting substance. The frosting and container device includes a wetting medium, a tray for storing the wetting medium a distance above a frosting substance, and a lid for enclosing the wetting medium and frosting substance within the tray.

### CROSS-REFERENCE TO RELATED APPLICATIONS

Not applicable.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention relates to a device for use in wetting and frosting the rim of a glass with a substance. In particular, the present invention relates to a glass frosting and container device for coating a rim of a drinking glass with a substance and for storing and transporting the substance for future applications.

2. Description of the Related Art

On many festive occasions it has become a common practice to decorate the rim of a drinking glass with an attractive, flavorful frosting substance. For instance, many people prefer a salt-coated glass rim when drinking a margarita. Others enjoy a tasty sugar coated rim with their daiquiris. Still others just enjoy the decorative color of salt or sugar on their glasses, such as those products provided by companies like Spectrum Gourmet of Colorado.

Several methods and devices have been created to apply frosting substances to rims. One tried and true method for applying salt to a margarita glass is to wet the rim with a cut lime and then invert the wetted rim into a salt container. While this method is effective, it can be messy and inconvenient.

Another device used to apply salt to a glass is disclosed U.S. Pat. No. 6,265,010. The device contains lime or other liquid within the perimeter of the lid and salt within a tray under the lid. A disadvantage of this device, however, is that the liquid sloshes around within the lid during use because there is no wetting medium to absorb the liquid. Another disadvantage is that none of the liquid can be saved for future applications but rather must be poured off before storage. Another disadvantage is that without a wetting medium, the wetting of the rim is inconsistent.

Another device used to apply salt to a margarita glass is disclosed in U.S. Pat. No. 3,450,096. This device includes a multitude of individually stacked trays, at least one tray having salt and another containing a sponge. A disadvantage of this device is its bulky size and multiplicity of trays to store the salt and sponge separately. Moreover, this device is not sealable, so it cannot be easily transported with the frosting substance within the trays.

### BRIEF SUMMARY OF THE INVENTION

Briefly, the present invention provides an improved glass frosting and container device for use in coating a rim of a beverage container with a frosting substance. The frosting and container device is compact and versatile because it can be used to apply a frosting substance to a beverage rim, and to store and transport the unused frosting substance and a wetting medium all in one container. Additionally, the lid of the container prevents spillage of the frosting substance during shipping. Moreover, the lid is constructed to receive the wetting medium and a liquid, and to minimize leakage of the liquid during application of the frosting substance.

The glass frosting and container device according to the present invention includes a wetting medium, a tray for storing the wetting medium a distance above the frosting substance, and a lid for enclosing the wetting medium and frosting substance within the tray. In operation, the wetting medium is removed from the tray and dampened with an appropriate liquid. After wetting the rim of a beverage container with the wetting medium, the rim is then dipped into the frosting substance contained within the tray. When all desired rims are frosted, the dampened wetting medium can be safely returned to the tray because it is supported a distance above the frosting substance.

### BRIEF DESCRIPTION OF THE SEVERAL VIEWS OF THE DRAWINGS

A better understanding of the present invention can be obtained when the following detailed description of the preferred embodiment is considered in conjunction with the following drawings, in which:

FIG. 1 is an elevational view of the present invention;

FIG. 2 is a cut-away view of the device of FIG. 1;

FIG. 3 is a cut-away view similar to FIG. 2;

FIG. 4 is an elevation view of a lid of the present invention;

FIG. 5 is a cut-away view of a lid of the present invention;

FIG. 6 is an elevational view of the present invention;

FIG. 7 is a cut-away view of an alternative embodiment of the present invention;

FIG. 8 is a cut-away view of an alternative embodiment of the present invention;

FIG. 9 is a cut-away view of an alternative embodiment of the present invention;

FIG. 10 is a cut-away view of an alternative embodiment of the present invention; and

FIG. 11 is a cut-away view of an alternative embodiment of the present invention.

### DETAILED DESCRIPTION OF THE INVENTION

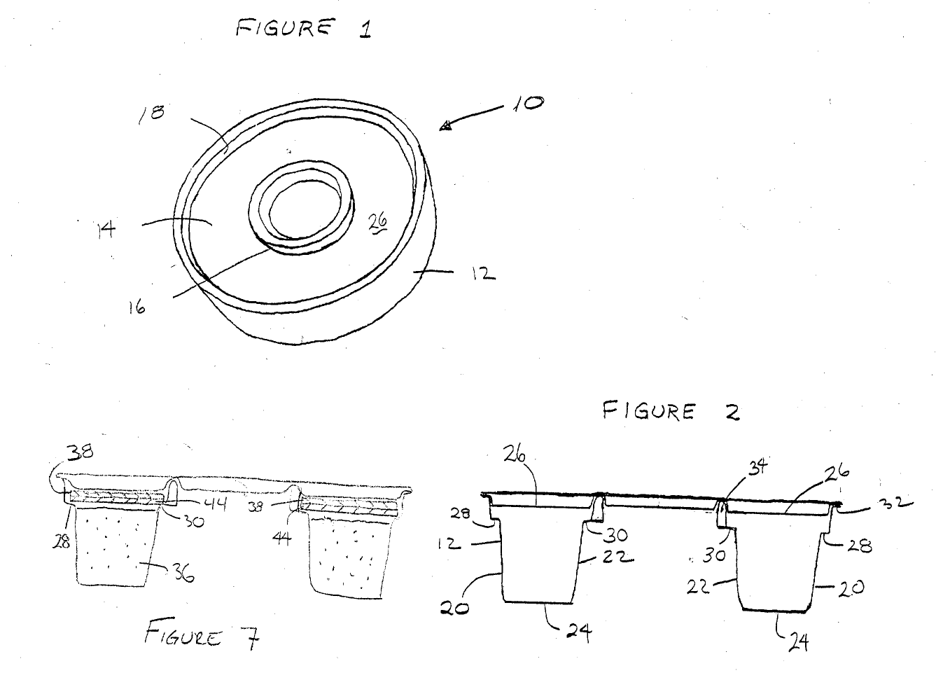

A glass frosting and container device 10 according to the present invention is shown in FIG. 1 in the closed position. As shown in FIGS. 1-3, the frosting and container device 10 includes a tray 12 for storing a frosting substance 36, a wetting medium 38 for wetting the rim of a glass or beverage container (not shown) and applying the frosting substance, and a lid 14 for enclosing the tray contents and wetting medium 38 prior to or after application of the frosting substance 36 to the rim and for holding the wetting medium 38 during application. A commonly used wetting medium 38 includes a sponge but, as discussed below, any medium that remains damp may be used. Examples of common frosting substances include salt, sugar, sprinkles, and other similar type favoring substances.

The lid 14 of the present invention includes an inner ridge 16 and an outer ridge 18 for receiving the sponge 38. As shown in FIGS. 4 and 5, during application of the salt 36 to the rim of a drinking glass, the lid 14 is removed from the tray 12 and the sponge 38 is set in the lid 14. As one of skill in the art can appreciate, the sponge 38 includes an opening sufficiently sized to fit over the inner ridge 16. The sponge 38 is then dampened with appropriate liquid, such as water, lime juice or a margarita mix. The ridges 16 and 18 prevent the liquid from leaking out of the lid 14. After wetting the rim with the sponge 38, the rim is then dipped in the salt 36 contained within the tray 12. The result: a tasty frosted rim for enjoyment with a beverage.

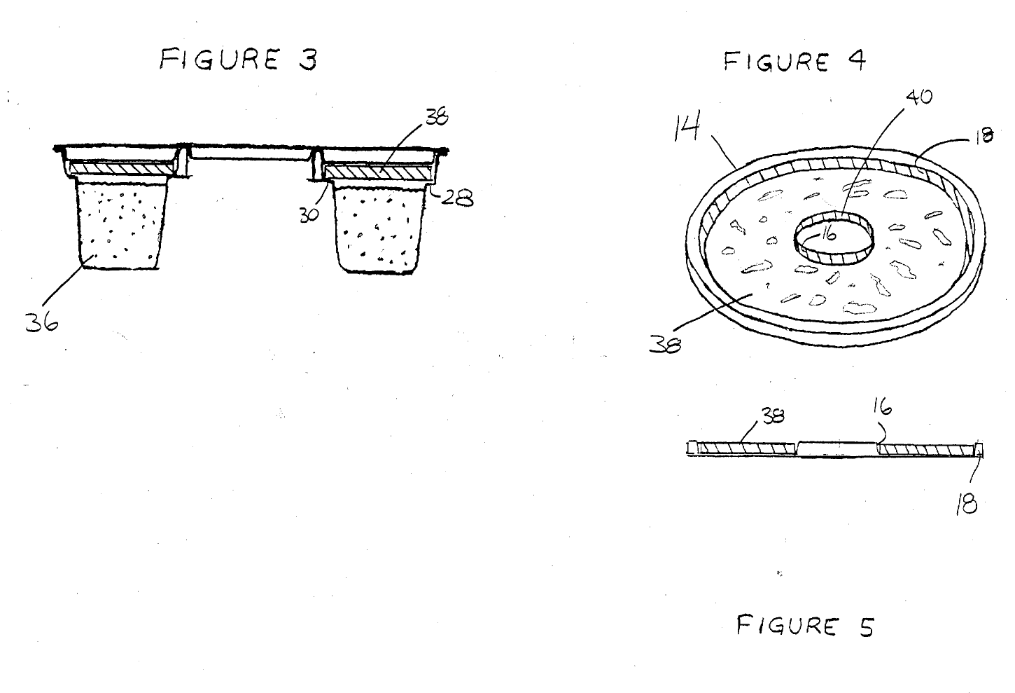

As shown in FIG. 3, when the sponge 38 is not being used to apply salt to a glass, it is stored within the tray 12. The tray 12 of the present invention includes outer and inner sidewalls 20 and 22 and a tray bottom 24. The walls 20, 22 and bottom 24 form a container for holding the salt 36. In the preferred embodiment, the walls 20, 22 include ledges 28 and 30. The ledges 28 and 30 support the sponge 38 a distance above the salt 36 to minimize undesired contact between a wet sponge and the salt. As can be appreciated, the sponge 38 is of sufficient rigidity such that it does not sag into the tray contents. Similarly, one can appreciate that an alternative embodiment for the tray 12 includes the use of only one ledge to support the sponge.

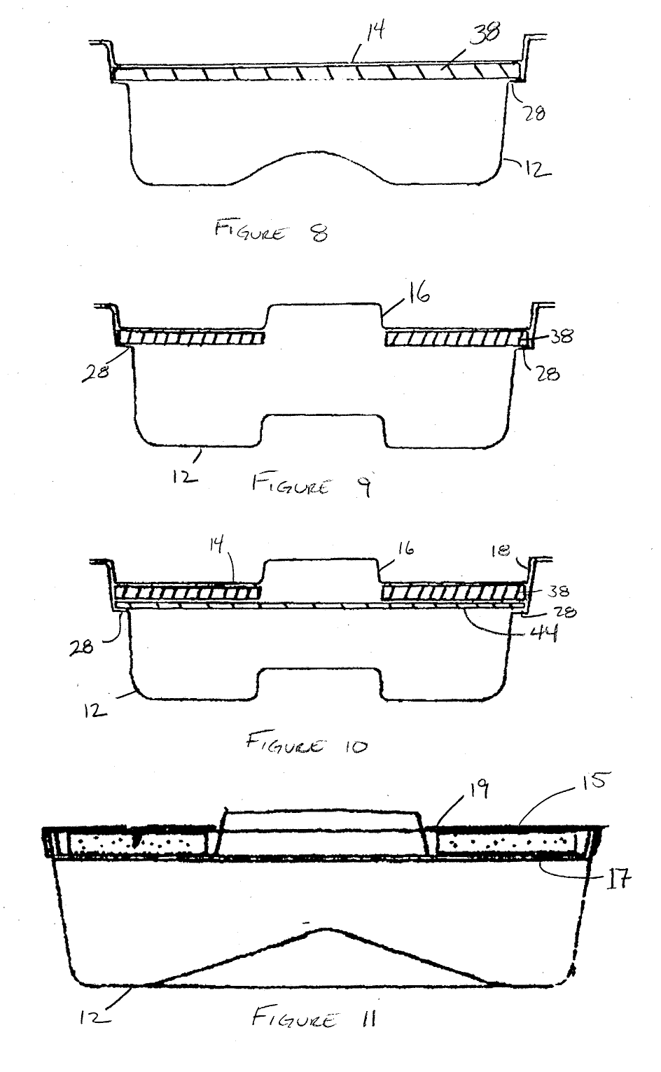

FIGS. 8 and 9 show an alternative embodiment for the glass frosting device 10. The tray 12 includes a single ledge 28 for supporting the sponge 3 a distance above the salt 36. In this embodiment, the lid 14 includes an outer ridge 18 for containing the sponge 38 within the lid 14 during application of the frosting substance. Alternatively, the lid 14 may include both the inner and ridges 16 and 18 and the sponge 38 would include an opening sufficiently sized to fit over the inner ridge 16. The lid 14 snaps tightly down onto the tray 12 to prevent the frosting substance from leaking.

FIG. 7 shows an alternative embodiment for keeping the wetting medium 38 away from the salt 36. In this embodiment, a removable plate 44 is with a removable plate, on top of the ledges 28 and 30. Alternatively, as shown in FIG. 10, the removable plate rests on the single ledge 28. The wetting medium 38 is set on the plate 44. In this embodiment, less rigid wetting medium, such as a cloth or other material, may be used instead of a sponge.

As shown in FIG. 2, the lid 14 securely fastens to the tray 12 to prevent the salt 36 from leaking during storage and transportation of the device 10. The tray 12 includes flanges 32 and a ring 34 for receiving the ridges 16 and 18 of the lid 14. The lid 14 is pushed down onto the tray 14 and snaps into place at the lip 32 and ring 34.

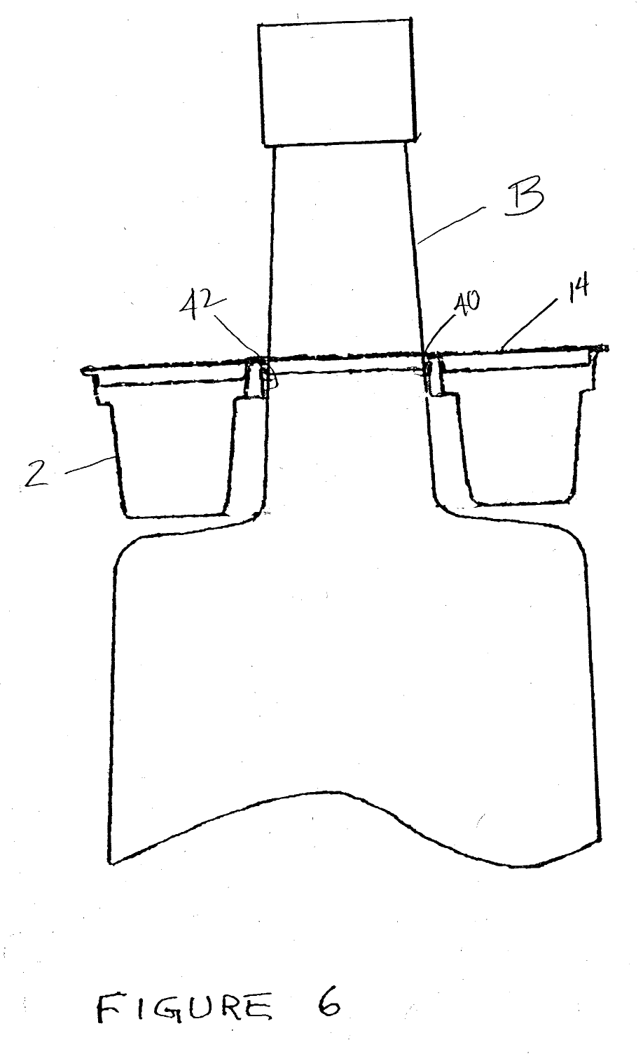

As shown in FIG. 6, an alternative embodiment includes a means for securing the frosting and container device 10 to the neck of a bottle B. In this embodiment, the tray 12 and lid 14 include openings 42 and 40 for receiving the bottle B. A second alternative embodiment includes securing the device 10 to the top of the bottle neck, in which case only the tray 12 includes an opening.

FIG. 11 shows an alternative embodiment having a two-piece lid 15. The lid 15 includes a lower piece 17 for holding the sponge 38 and containing the frosting medium with the tray 14. The lower section 17 snaps into place to cover the tray 14. An upper piece 19 encapsulates the sponge 38 within the lower piece 17.

The foregoing disclosure and description of the invention are illustrative and explanatory thereof, and various changes in the details of the illustrated apparatus and construction and method of operation may be made without departing from the spirit of the invention.

I claim:

1. A glass frosting and container device for use in coating a rim of a glass with a frosting substance comprising:
a wetting medium;
a tray for storing said frosting substance and said wetting medium, said tray having a sidewall for supporting said wetting medium a distance above the frosting substance; and
a lid for enclosing said wetting medium and the frosting substance within said tray.

2. The glass frosting and container device according to claim 1, wherein said wetting medium is a sponge.

3. The glass frosting and container device according to claim 1, wherein said tray includes an opening for receiving a bottle neck.

4. The glass frosting and container device according to claim 1, wherein said tray and said lid include openings for receiving a bottle neck.

5. The glass frosting and container device according to claim 1, wherein said lid includes a ridge for containing said wetting medium and said frosting substance during the frosting of a glass.

6. The glass frosting and container device according to claim 1, wherein said sidewall includes a ledge for supporting said wetting medium.

7. The glass frosting and container device according to claim 1, further comprising:
an insert plate for supporting said wetting medium, said plate supported by said sidewall.

8. A glass frosting and container device for use in coating a rim of a glass with a frosting substance comprising:
a sponge;
a tray for storing said frosting substance and said sponge, said tray having a ledge for supporting said sponge a distance above the frosting substance;
a lid for enclosing said sponge and the frosting substance within said tray.

9. The glass frosting and container device according to claim 9, wherein said tray includes an opening for receiving a bottle neck.

10. The glass frosting and container device according to claim 9, wherein said tray and said lid include openings for receiving a bottle neck.

11. The glass frosting and container device according to claim 9, wherein said lid includes a ridge for containing said sponge and said frosting substance during the frosting of a glass.

12. The glass frosting and container device according to claim 9, further comprising:
an insert plate for supporting said wetting medium, said plate supported by said sidewall.

13. A glass frosting and container device for use in coating a rim of a glass with a frosting substance comprising:
a wetting medium;
a tray for storing said frosting substance and said wetting medium, said tray having a sidewall for supporting said wetting medium a distance above the frosting substance;
a first lid for holding said wetting medium and containing said frosting substance within said tray; and
a second lid for encapsulating said wetting medium within said first lid.
